(19) United States
(12) Patent Application Publication
(10) Pub. No.: US 2008/0156151 A1
(43) Pub. Date: Jul. 3, 2008

(54) STEPLESS TELESCOPIC HAND TOOL

(76) Inventor: Chia Yu Chen, Taichung (TW)

Correspondence Address: TROXELL LAW OFFICE PLLC, SUITE 1404, 5205 LEESBURG PIKE, FALLS CHURCH, VA, 22041, US

(21) Appl. No.: 11/647,161

(22) Filed: Dec. 29, 2006

(51) Int. Cl. B25B 23/16; G05G 1/10; B25B 13/46; B25G 1/10

(52) U.S. Cl. 81/177.2; 74/553; 81/60; 16/430

(57) ABSTRACT

A stepless telescopic hand tool includes a main body, a bar and a positioning device. The positioning device is installed between the main body and the bar, consisting of a rotating knob and a torsion spring. The rotating knob has an engaging hole bored axially at one side for correspondingly engaging with the bar and a penetrating hole bored at the other side for engaging with the main body. The torsion spring has a locking end at its two sides respectively for fitting in a hole of the bar and a locking hole of the rotating knob, for pivotally fitting the positioning device with the bar, enabling the main body to move freely while twisting the rotating knob and be tightened in case of releasing the rotating knob from being twisted.

### BACKGROUND OF THE INVENTION

1. Field of the Invention

This invention relates to a hand tool, particularly to one having a positioning device provided with a rotating knob that can control a main body to move in a bar freely or be tightened at any location.

2. Description of the Prior Art

Commonly, as shown in FIG. 1, a conventional telescopic hand tool 10 is composed of a main body 11, a bar 12 and a restricting device 13. The main body 11 is provided with plural annular grooves 111 set axially at preset locations. The restricting device 13 is installed between the main body 11 and the bar 12, provided with restricting balls 131 employed to lock in the annular grooves 111 of the main body 11. In using, when the position of the main body 11 is to be adjusted, first, the restricting device 13 has to be continuously pushed axially to loosen the restricting balls 131. The annular groove 111 is spontaneously freed from being positioned by the restricting balls 131, so that the main body 11 can be removed to another location. Then, stop forcing the restricting device 13, letting the restricting balls 131 move back to its original position to keep the annular groove 11 locked by the restricting balls 131 again. But, because the annular grooves 111 are spaced apart in a certain distance, it is impossible to keep the main body 11 positioned at any point between two adjacent annular grooves 111, causing a limitation of controllable length. Moreover, to lathe the annular groves 111 involves augmenting manufacturing cost additionally.

### SUMMARY OF THE INVENTION

The objective of this invention is to offer a stepless telescopic hand tool.

The main characteristics of the invention are a main body, a bar and a positioning device. The bar is provided with an engaging member formed in a front portion, having an axial opening for engaging with a telescopic bar of the main body. The engaging member is provided with a hole dug near the edge of the axial opening and an annular projection projected around the inner wall of the axial opening behind the hole. The positioning device is installed between the main body and the bar, provided with a rotating knob and a torsion spring. The rotating knob is provided with an engaging hole bored axially at one side for correspondingly engaging with the engaging member of the bar, and a penetrating hole bored at the other side for engaging with the main body. There is an annular projection set around the inner wall of the rotating knob at the inner end of the engaging hole. A locking hole is concaved at a preset location of the annular projection. The torsion spring is provided with a locking end at its two sides respectively for fitting in the hole of the engaging member and the locking hole of the rotating knob, enabling the rotating device fitted pivotally with the bar. Therefore, the main body can be axially moved to and fro while twisting the rotating knob, and tightened restrictively by the torsion spring in case of releasing the torsion spring. In other words, when the rotating knob is twisted, the torsion spring is spontaneously twisted to loosen the telescopic bar of the main body, enabling the main body to move axially in the bar freely to have any length desired. And, when the rotating knob is released from being twisted, the torsion spring is to re-tighten the telescopic bar of the main body owing to its elasticity. Thus, the invention can be easily operated to alter its length randomly. Moreover, there is no annular groove needed to be lathed as the conventional one does, relatively reducing manufacturing cost and time.

### BRIEF DESCRIPTION OF DRAWINGS

This invention is better understood by referring to the accompanying drawings, wherein:

FIG. 1 is a cross-sectional view of a conventional telescopic hand tool;

FIG. 2 is a perspective view of a first preferred embodiment of a stepless telescopic hand tool in the present invention;

FIG. 3 is an exploded perspective view of the first preferred embodiment of a stepless telescopic hand tool in the present invention;

FIG. 4 is a cross-sectional view of the first preferred embodiment of a stepless telescopic hand tool in the present invention;

FIG. 5 is a cross-sectional view of the first preferred embodiment of a stepless telescopic hand tool in the present invention, showing a telescopic bar being tightened by a torsion spring;

FIG. 6 is a cross-sectional view of the first preferred embodiment of a stepless telescopic hand tool in the present invention, showing the telescopic bar being released by the torsion spring;

FIG. 7 is a partial exploded perspective view of a second preferred embodiment of a stepless telescopic hand tool in the present invention; and

FIG. 8 is a perspective view of a third preferred embodiment of a stepless telescopic hand tool in the present invention.

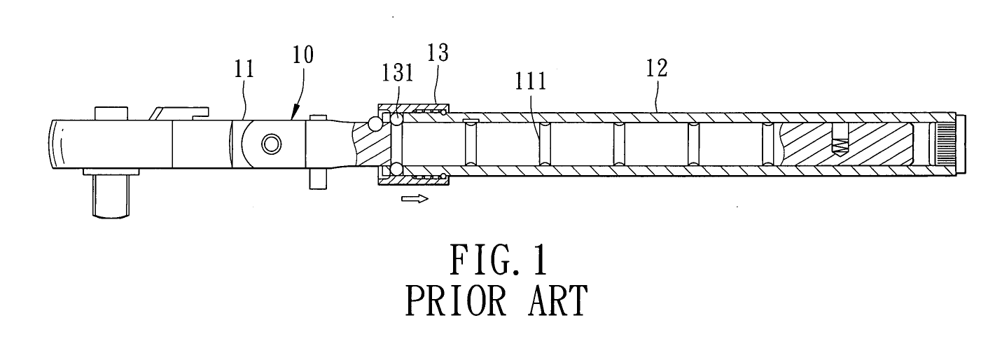

### DETAILED DESCRIPTION OF THE PREFERRED EMBODIMENT

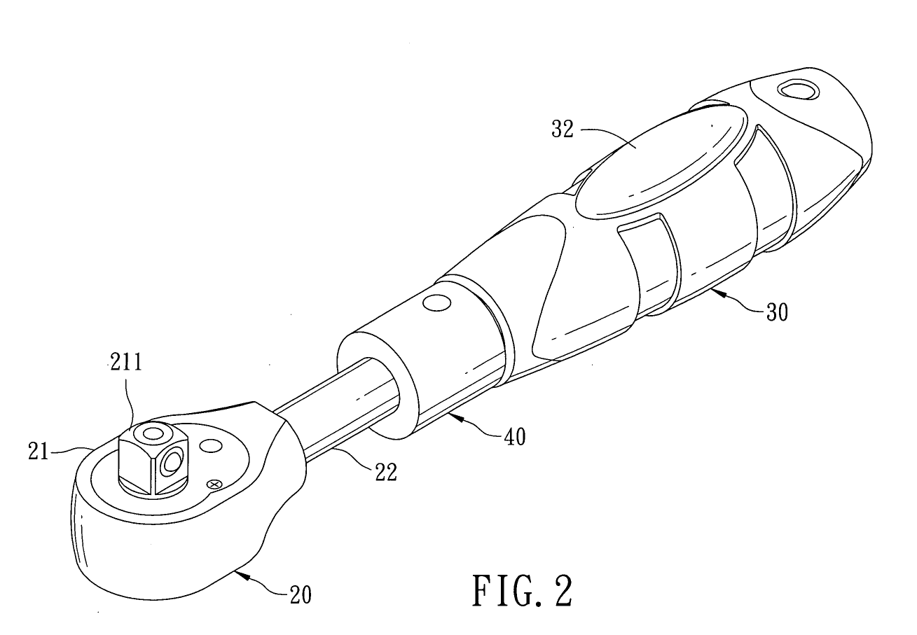

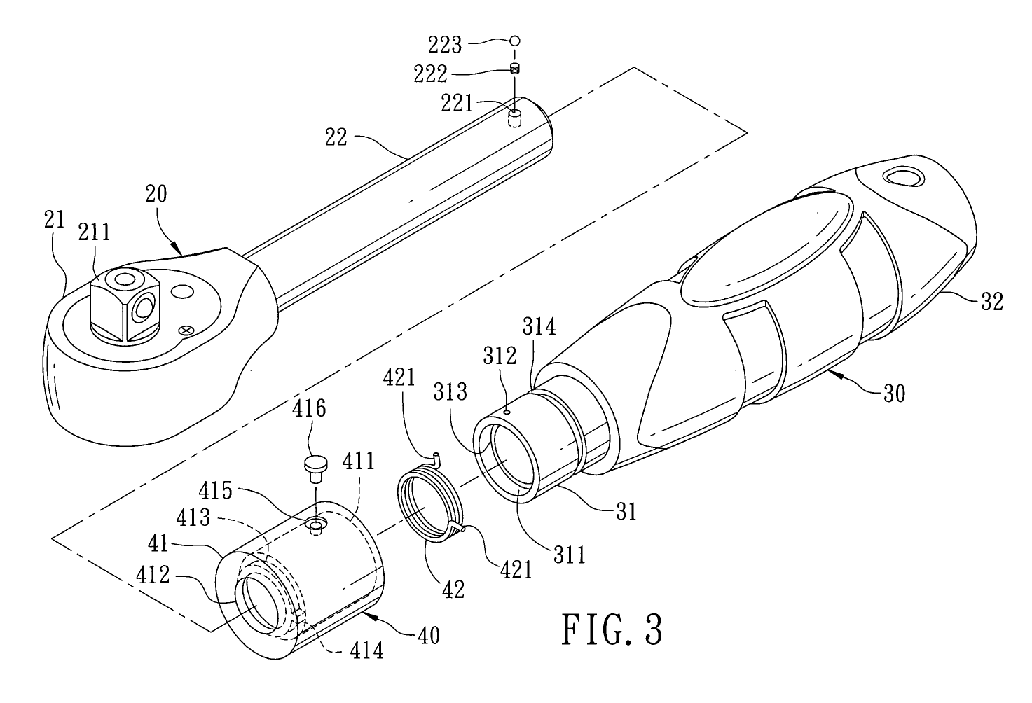

As shown in FIGS. 2 and 3, a first preferred embodiment of a stepless telescopic hand tool in the present invention is composed of a main body 20, a bar 30 and a positioning device 40.

The main body 20 is provided with a working head 21 located at its front portion, which is provided with a ratchet set 211 for engaging with a tool. The working head 21 is also provided with a telescopic bar 22 located at its rear portion. The telescopic bar 22 is provided with a positioning hole 221 dug at its end for containing an elastic element 222 and a positioning ball 223 having a diameter smaller than that of the positioning hole 221.

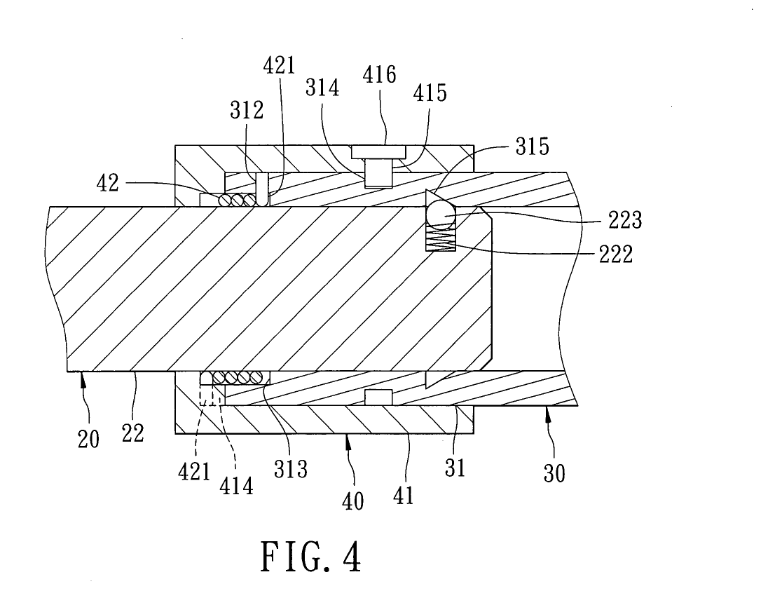

The bar 30 formed as an annular column consists of an engaging member 31 formed in a front portion a grip 32 formed in a rear portion for a user to hold. The engaging member 31 is provided with an axial opening 311 dug axially for engaging with the telescopic bar 22 of the main body 20, a hole 312 dug near the edge of the axial opening 311 and an annular projection 313 projected around the inner wall of the axial opening 311 behind the hole 312. In addition, the engaging member 31 has also an annular restricting slot 314 set on the outer surface at the end, and a groove 315 located in its inner wall behind the annular restricting slot 314, as shown in FIG. 4.

The positioning device 40 is installed between the main body 20 and the bar 30, composed of a rotating knob 41 and a torsion spring 42. The rotating knob 41 formed cylindrical can be made of metal or plastics, provided with an engaging hole 411 bored axially at one side for correspondingly engaging with the engaging member 31 of the bar 30, and a penetrating hole 412 bored at its other side for engaging with the telescopic bar 22 of the main body 20. The rotating knob 41 is also provided with an annular projection 413 set in its inner wall around the end of the engaging hole 411, a locking hole 414 concaved at a preset location of the annular projection 413, and a restricting hole 415 bored at its outer surface corresponding to the annular restricting slot 314 of the bar 30 for a restricting bolt 416 to pass through to lock in the annular restricting slot 314. The torsion spring 42 having a diameter equal to that of the telescopic bar 22 of the main body 20 is provided with a locking end 421 at its upper and lower sides respectively. In assembly, as shown in FIG. 4, one of the locking ends 421 of the torsion spring 42 is first inserted in the hole 312 of the bar 30 to let the torsion spring 42 to fit on the annular projection 313 of the engaging member 31 and then, turn the rotating knob 41 to engage with the engaging member 31 of the bar to keep the other locking end 421 of the torsion spring 42 locked in the locking hole 414 of the rotating knob 41, enabling the torsion spring 42 pivotally fixed between the annular projection 313 of the bar 30 and the annular projection 413 of the rotating knob 41. Next, the restricting bolt 416 is put through the restricting hole 415 of the rotating knob 41 to lock in the annular restricting slot 314 of the bar 30, keeping the rotating knob 41 pivotally fixed with the bar 30. And, the torsion spring 42 can keep the telescopic bar 22 of the main body 20 tightened fixedly in the engaging member 31 of the bar 30.

In addition, the positioning ball 223 and the elastic element 222 must be pressed in the telescopic bar 22 of the main body 20 so as to be placed inside the torsion spring 42, keeping the telescopic bar 22 of the main body 20 engaged with the engaging member 31 of the bar 30. Then the assembly of the invention is finished.

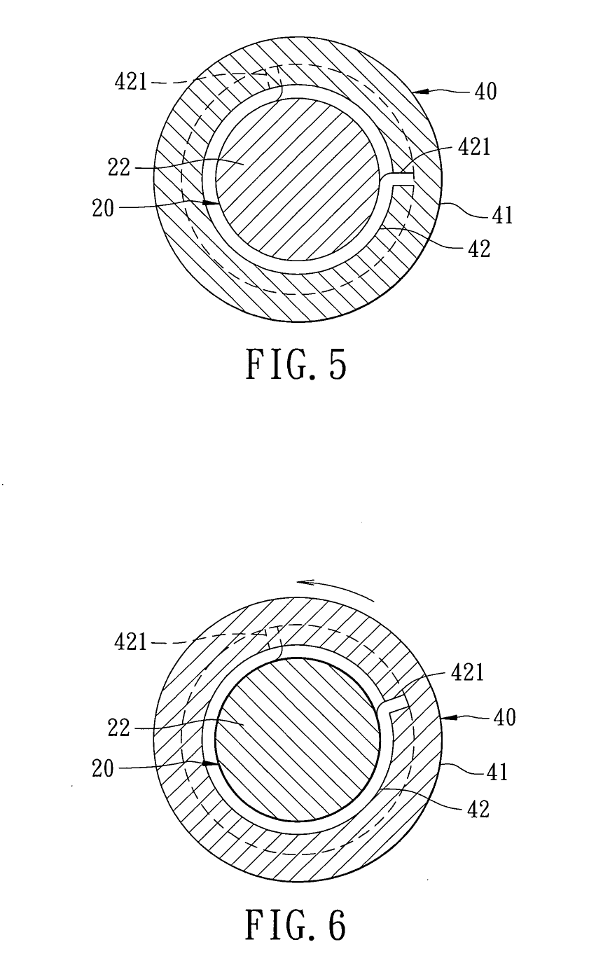

In using, as shown in FIGS. 4 and 5, when the length of the main body 20 is to be altered, twist the rotating knob 41 in one direction to keep the locking end 421 of the torsion spring 42 locked in the positioning hole 414 of the rotating knob 41 twisted spontaneously. By the time, as shown in FIG. 6, the torsion spring 42 expands outwards to make its diameter bigger than that of the telescopic bar 22 of the main body 20, so that the telescopic bar 22 is freed from being tightened by the torsion spring 42, able to move freely in the axial opening 311 of the engaging member 31 of the bar 30 for changing its location. And, when the torsion spring 42 is released from being twisted, it is to re-tighten the telescopic bar 22 of the main body 20 owing to its elasticity, as shown in FIG. 5, keeping the telescopic bar 22 of the main body 20 automatically positioned immovably at any desired location. In addition, it should be noted that the positioning ball 223 is to be pushed by the spring element 222 to be pivotally locked by the groove 315 of the engaging member 31 if the telescopic bar 22 of the main body 20 is pulled outward to its extreme end, able to prevent the bar 20 from moving out of the bar 30 for a safety concern.

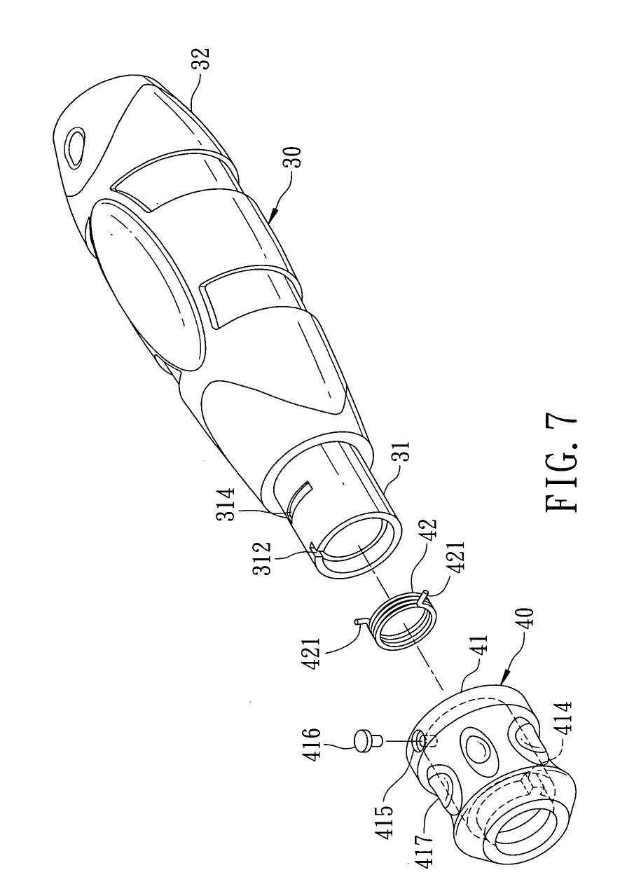

As shown in FIG. 7, a second preferred embodiment of a stepless telescopic hand tool in the present invention has the same components as the first embodiment does except the annular restricting slot 314 and the hole 312 of the engaging member 31 and the rotating knob 41. The annular restricting slot 314 is only partially dug in a certain arc to limit a maximum movement for the restricting bolt 416 to move while twisting the rotating knob 41. The hole 312 of the engaging member 31 of the bar 30 is formed as a jag for the locking end 421 of the torsion spring 42 to fit in advance and then, the other locking end 421 is fitted in the positioning hole 414 of the rotating knob 41, enabling the torsion spring 42 pivotally restricted between the bar 30 and the rotating knob 41. In addition, the rotating knob 41 is made of plastics integrally, provided with plural bulges 417 on its surface for enhance the friction coefficient of the rotating knob 41.

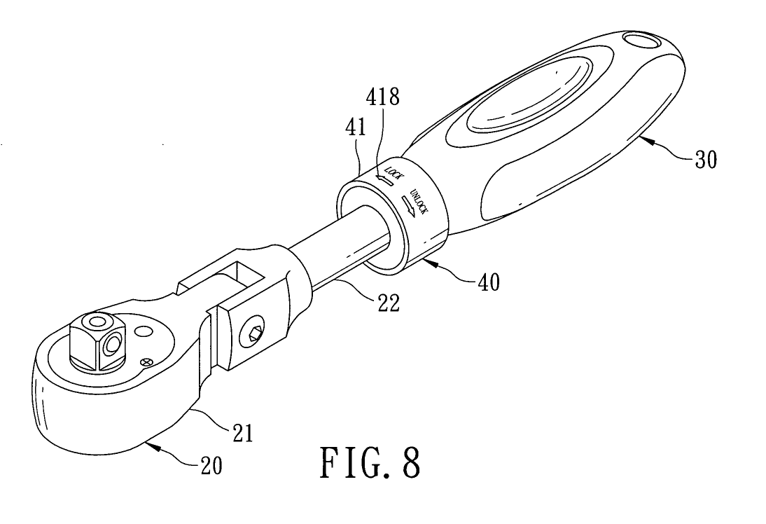

As shown in FIG. 8, a third preferred embodiment of a stepless telescopic structure of a hand tool in the present invention has the same components as the first embodiment does, except that the working head 21 is connected pivotally with the telescopic bar 22 to keep the working head 21 foldable in some certain angles, and the rotating knob 41 is provided with marks 418 indicating directions of twisting the rotating knob 41.

The invention has the following advantages as can be seen from the foresaid description.

1. The telescopic bar 22 of the main body 20 can move to and fro as long as the rotating knob 41 is twisted in one direction, and be tightened immovably again at a desired location owing to the elasticity of the torsion spring 42 while releasing the rotating knob 41, affording a very simple operation of the invention.

2. The telescopic bar 21 can be moved to change its length randomly, able to further satisfy a user's demand for advancing competition in the market.

While the preferred embodiment of the invention has been described above, it will be recognized and understood that various modifications may be made therein and the appended claims are intended to cover all such modifications that may fall within the spirit and scope of the invention.

What is claimed is:

1. A stepless telescopic hand tool comprising:
a main body provided with a working head in its front portion for engaging with a tool and a telescopic bar at its rear portion;
a bar consisting of an engaging member formed in a front portion, said engaging member provided with an axial opening bored axially for placing said telescopic bar of said main body, a hole bored near its front annular edge, an annular projection projected around an inner wall of said axial opening behind said hole and an annular restricting slot set around its outer surface; and
a positioning device installed between said main body and said bar and composed of a rotating knob and a torsion spring, said rotating knob formed cylindrical and provided with an engaging hole bored axially for correspondingly engaging with said engaging member of said bar and a penetrating hole bored at its other end for engaging with said telescopic bar of said main body, an annular projection set around an inner wall of said rotating knob at an inner end of said engaging hole, a locking hole concaved at a preset location of said annular projection, a restricting hole bored on the outer surface of said rotating knob corresponding to said annular restricting slot of said bar for a restricting bolt to pass through to lock in said annular restricting slot so as to keep said positioning device locked fixedly with said bar, said torsion spring having a diameter equal to that of said telescopic bar of said main body and provided with a locking end at its upper and its lower side respectively, said locking ends respectively inserted in said engaging member of said bar and said locking hole of said rotating knob so that said positioning device can be pivotally fixed with said bar and said torsion spring is able to tighten said telescopic bar in said engaging member of said bar.

2. A stepless telescopic structure of a hand tool as claimed in claim 1, wherein said telescopic bar is provided with a positioning hole concaved at its end, an elastic element and a positioning ball pivotally stored in said positioning hole, said elastic element having a diameter smaller than that of said positioning hole and able to push said positioning ball to be restricted in said engaging member while placing said telescopic bar of said main body into said engaging member of said bar, said engaging member also provided with a groove located in its inner wall behind said annular restricting slot for said telescopic bar of said main body to fit pivotally with said engaging member by means of said positioning ball forced elastically by said elastic element.

3. A stepless telescopic hand tool as claimed in claim 1, wherein said hole of said engaging member is taken place by a jag.

4. A stepless telescopic hand tool as claimed in claim 1, wherein said annular restricting slot is dug in a complete circumference corresponding to said restricting hole.

5. A stepless telescopic hand tool as claimed in claim 1, wherein said annular restricting slot is dug only in a partial circumference corresponding to said restricting hole, for limiting a maximum movement of said restricting bolt.

6. A stepless telescopic hand tool as claimed in claim 1, wherein said bar is provided with a grip formed in a rear portion oppositely to said engaging member.

7. A stepless telescopic hand tool as claimed in claim 1, wherein said rotating knob is made of metal.

8. A stepless telescopic hand tool as claimed in claim 1, wherein said rotating knob is made of plastics.

9. A stepless telescopic hand tool as claimed in claim 1, wherein said rotating knob is provided with plural bulges on its outer surface for enhancing its friction coefficient.

10. A stepless telescopic hand tool as claimed in claim 1, wherein said rotating knob is provided with marks on its surface.
